(19) United States
(12) Patent Application Publication
(10) Pub. No.: US 2013/0076997 A1
(43) Pub. Date: Mar. 28, 2013

(54) ACTIVE SHUTTER GLASSES, PASSIVE GLASSES, AND STEREOSCOPIC IMAGE PROJECTION SYSTEM

(71) Applicants: Akira Sakai, Osaka-shi (JP); Kazuyoshi Sakuragi, Osaka-shi (JP); Masahiro Hasegawa, Osaka-shi (JP)

(72) Inventors: Akira Sakai, Osaka-shi (JP); Kazuyoshi Sakuragi, Osaka-shi (JP); Masahiro Hasegawa, Osaka-shi (JP)

(21) Appl. No.: 13/583,090

(22) PCT Filed: Nov. 10, 2010
(86) PCT No.: PCT/JP2010/070008

§ 371 Date: Nov. 16, 2012

(30) Foreign Application Priority Data
Mar. 8, 2010 (JP) 2010-051000

(51) Int. Cl. G02F 1/1335; G02B 27/26

(52) U.S. Cl. 349/13; 359/465

(57) ABSTRACT

The present invention provides active shutter glasses, passive glasses, and a stereoscopic image projection system, with which a viewer wearing polarizing sunglasses can enjoy improved visibility. The active shutter glasses comprises: a shutter for a right eye; and a shutter for a left eye, wherein the shutters for a right eye and for a left eye each have a liquid crystal cell and a linearly polarizing element, the linearly polarizing element is provided in each shutter on an inner side than the liquid crystal cell is, the linearly polarizing element has a transmission axis direction set in the vertical direction when the glasses are worn.

### TECHNICAL FIELD

The present invention relates to active shutter glasses, passive glasses, and a stereoscopic image projection system. More specifically, the present invention relates to active shutter glasses, passive glasses, and a stereoscopic image projection system which are suitably used in a stereoscopic image projection system of an active shutter or passive system.

### BACKGROUND ART

Known as stereoscopic image projection systems using glasses are an anaglyph system, a passive system, an active system, and the like. In the anaglyph system, the display quality is extremely low, and so-called crosstalk is caused.

In the passive system and the active system, polarizing glasses are used. In the passive system, lightweight polarizing glasses can be manufactured at low cost. On the other hand, the active system provides excellent display performance. For example, in the case where a video display device for a stereoscopic image projection system (hereinafter, also referred to as 3D display device) has a resolution of full high-vision (1920×1080), stereoscopic display can be performed with the resolution of full high-vision as it is. The performance required of the 3D display device of the active system is mainly a high frame rate and high-performance image processing, and even an existing high-end video display device can satisfy these requirements. Namely, even prior to the spread of 3D contents, the existing video display device can be used as a 3D display device without incorporation of a special member into the video display device itself.

Hereinafter, polarizing glasses used in the passive system is referred to as passive glasses and polarizing glasses used in the active system is referred to as active shutter glasses.

Liquid crystal display devices are now practically used as video display devices which realize reduction in thickness, weight, and power consumption, and they are widely used in various fields.

With regard to liquid crystal display devices, a technique is disclosed for improving the visibility through polarizing sunglasses.

An exemplary technique includes: providing a phase plate in front of a front-side polarizing plate of a liquid crystal display device; and setting the retardation Δn·d of the phase plate to 110 to 170 nm and angle a between an optical axis of the phase plate and an absorption axis of the front-side polarizing plate to 35° to 55° (see Patent Literature 1).

Also disclosed is a liquid crystal display device mentioned below (see Patent Literature 2). The liquid crystal display device has a liquid crystal display panel, a first polarizing plate, a second polarizing plate, and a half-wave plate. In the liquid crystal display panel, liquid crystals are sandwiched between two substrates. The polarizing plate is, for example, an upper polarizing plate, and is positioned on one of the two substrates and on the side of the substrate not facing the liquid crystals in the liquid crystal display panel. The half-wave plate is positioned on the polarizing plate. In the half-wave plate, the direction of a phase advance axis is set such that a polarization direction of light exiting from the transmission axis of the polarizing plate is rotated by an angle within a range of 90±15[°].

### CITATION LIST

[Patent Literature 1]

Japanese Kokai Publication No. 6-258633 (JP-A 6-258633)

[Patent Literature 2]

Japanese Kokai Publication No. 2008-83115 (JP-A 2008-83115)

### SUMMARY OF INVENTION

### Technical Problems

Polarizing sunglasses are commonly designed to absorb polarization components vibrating in the lateral (horizontal) direction and transmit polarization components vibrating in the vertical direction. The reason for this is that S wave (polarized light vibrating perpendicular to the entrance plane) is commonly in the ascendant in the reflected light strength and the light emitted from the light source (sun light, fluorescent lump, and the like) and reflected from the horizontal plane such as floors, desktops, and water surfaces is vibrating mainly in the lateral (horizontal) direction because of the Fresnel effect. Accordingly, a light transmitting part in the polarizing sunglasses is provided with a linearly polarizing element. The linearly polarizing element has a transmission axis direction set in the vertical direction when the polarizing sunglasses are worn by a user.

The present inventors found out that the following problems may occur, when the viewer wears polarizing sunglasses, in the stereoscopic image projection system using polarizing glasses.

First, a description is given on the active system. As illustrated in FIG. 14, if transmission axes 622t of linearly polarizing elements 622 on the viewer side of active shutter glasses 620 are not parallel with transmission axes 642t of linearly polarizing elements 642 of polarizing sunglasses 640, the screen brightness of a video display device 610 is lowered. In the case where the transmission axes 622t and 642t are orthogonal to each other, stereoscopic video is not visible and the viewer's sight becomes completely black, which is significantly dangerous and not at all practical. The cause of these problems is that the transmissivity of two linearly polarizing elements superimposed at a relative angle θ is proportional to the square of cosθ. In the case of θ=90°, the transmissivity is substantially zero.

Next, a description is given on the passive system. As illustrated in FIG. 15, passive glasses 720 have a light transmitting part 721R for a right eye and a light transmitting part 721L for a left eye respectively provided with a linearly polarizing element 722R and a linearly polarizing element 722L. A transmission axis 722R,t of the linearly polarizing element 722R and a transmission axis 722L,t of the linearly polarizing element 722L are orthogonal to each other. In the case where the transmission axis 722L,t is set in the vertical direction and the transmission axis 722R, t is set in the lateral direction as illustrated in FIG. 15, the viewer's sight on the right side becomes almost black. In addition, in the case where the transmission axes 722R,t and 722L,t are set diagonal (e.g. 45° angle direction) as illustrated in FIG. 16, the transmissivity of the light transmitting parts 721R and 721L is lowered, so that a bright stereoscopic video is not visible.

As illustrated in FIG. 17, passive glasses 820 has a light transmitting part 821R for a right eye provided with a right-handed circularly polarizing plate and a light transmitting part 821L for a left eye provided with a left-handed circularly polarizing plate. More specifically, as illustrated in FIG. 18, the light transmitting part 821R is provided with a linearly polarizing element 822R and a λ/4 plate 827R, and the light transmitting part 821L is provided with a linearly polarizing element 822L and a λ/4 plate 827L. A transmission axis 822R,t of the linearly polarizing element 822R is set in the lateral direction and a transmission axis 822L,t of the linearly polarizing element 822L is set in the vertical direction. A slow axis 827R,s of the λ/4 plate 827R and a slow axis 827L of the λ/4 plate 827L are both set in a direction tilt by 45° from the vertical direction. Accordingly, in this case too, the viewer's sight on the right side becomes almost black.

Upon using a 3D display device, these problems may be solved by temporal removal of polarizing sunglasses. However, this solution still has a problem to be solved because of the following reasons. Namely, in the West where the sunlight is often strong, the usage rate of polarizing sunglasses is high and prescription polarizing sunglasses are in widespread use. If the viewer wears prescription polarizing sunglasses for controlling his/her vision, the viewer cannot take the polarizing sunglasses off even when watching video on a 3D display device.

The present invention has been devised in consideration of the state of the art, and aims to provide active shutter glasses, passive glasses, and a stereoscopic image projection system, with which a viewer wearing polarizing sunglasses can enjoy improved visibility.

### Solution to Problem

The present inventors have intensively studied about polarizing glasses which allow a viewer wearing polarizing sunglasses to enjoy improved visibility, and noted the light immediately prior to entry into the polarizing sunglasses. In the above-mentioned examples, the vibration direction (polarization direction) of at least a part of polarized light having passed through polarizing glasses is not parallel with the transmission axis of polarizing sunglasses. As a result, the visibility is lowered. The present inventors further found out that the above problems can be solved by the following settings. Namely, in the case of active shutter glasses, the direction of the transmission axis of a linearly polarizing element (inner polarizing element) that is provided on an inner side than a liquid crystal cell is, is set in the vertical direction (pattern 1), or a layer (polarization conversion layer) for converting polarization is provided on an inner side than the inner polarizing element is (pattern 2). In the case of passive glasses, the direction of the transmission axis of a linearly polarizing element is set in the vertical direction (pattern 1) or a polarization conversion layer is provided on an inner side than the linearly polarizing element is. In this manner, the present invention was completed.

Namely, the present invention provides active shutter glasses for a stereoscopic image projection system, comprising: a shutter for a right eye; and a shutter for a left eye, wherein the shutters for a right eye and for a left eye each have a liquid crystal cell and a linearly polarizing element, the linearly polarizing element (inner polarizing element) is provided in each shutter on an inner side than the liquid crystal cell is, the linearly polarizing element has a transmission axis direction set in the vertical direction when the glasses are worn (hereinafter, also referred to as a first active shutter glasses of the present invention). This allows the viewer wearing polarizing sunglasses to enjoy improved visibility in the active system.

The configuration of the first active shutter glasses of the present invention is not especially limited as long as it essentially includes such components. The first active shutter glasses may or may not include other components.

In the first active shutter glasses of the present invention, the linearly polarizing element is a first linearly polarizing element, the shutters for a right eye and for a left eye each further have a second linearly polarizing element and a polarization conversion layer for converting polarization, the second linearly polarizing element (outer polarizing element) is provided in each shutter on an outer side than the liquid crystal cell is, and the polarization conversion layer is provided in each shutter on an outer side than the second linearly polarizing element is. This solves the problems which may occur when a liquid crystal display device is used as a 3D display device. This embodiment is particularly suitable for a stereoscopic image projection system in which a liquid crystal display device is used as a 3D display device.

The present invention also provides active shutter glasses for a stereoscopic image projection system, comprising: a shutter for a right eye; and a shutter for a left eye, wherein the shutters for a right eye and for a left eye each have a liquid crystal cell, a linearly polarizing element, and a polarization conversion layer for converting polarization, the linearly polarizing element (inner polarizing element) is provided in each shutter on an inner side than the liquid crystal cell is, the polarization conversion layer is provided in each shutter on an inner side than the linearly polarizing element is (hereinafter, also referred to as a second active shutter glasses of the present invention). This allows the viewer wearing polarizing sunglasses to enjoy improved visibility in the active system.

The configuration of the second active shutter glasses of the present invention is not especially limited as long as it essentially includes such components. The second active shutter glasses may or may not include other components.

In the second active shutter glasses of the present invention, the polarization conversion layer maybe a λ/2 plate. This further improves the visibility.

The present invention also provides a stereoscopic image projection system comprising the first or second active shutter glasses. This allows the viewer wearing polarizing sunglasses to enjoy improved visibility in a stereoscopic image projection system of the active system.

The present invention also provides passive glasses for a stereoscopic image projection system, comprising: a light transmitting part for a right eye; and a light transmitting part for a left eye, wherein the light transmitting parts for aright eye and for a left eye each have a linearly polarizing element, and the linearly polarizing element has a transmission axis direction set in the vertical direction when the glasses are worn (hereinafter, also referred to as first passive glasses of the present invention). This allows the viewer wearing polarizing sunglasses to enjoy improved visibility in the passive system.

The configuration of the first passive glasses of the present invention is not especially limited as long as it essentially includes such components. The first passive glasses may or may not include other components.

The present invention also provides passive glasses for a stereoscopic image projection system, comprising: a light transmitting part for a right eye; and a light transmitting part for a left eye, wherein the light transmitting parts for aright eye and for a left eye each have a linearly polarizing element, and at least one of the light transmitting parts for a right eye and for a left eye has a polarization conversion layer for converting polarization, and the polarization conversion layer is provided in the light transmitting part on an inner side than the linearly polarizing element is (hereinafter, also referred to as second passive glasses of the present invention). This allows the viewer wearing polarizing sunglasses to enjoy improved visibility in a stereoscopic image projection system of the active system.

The configuration of the second passive glasses of the present invention is not especially limited as long as it essentially includes such components. The second passive glasses may or may not include other components.

In the second passive glasses of the present invention, the light transmitting parts for a right eye and for a left eye each may have the polarization conversion layer. This embodiment is suitable for the case where directions of transmission axes of light transmitting parts for a right eye and for a left eye are both set not in the vertical direction.

In the second passive glasses of the present invention, one of the light transmitting parts for a right eye and for a left eye may have the polarization conversion layer. This embodiment is suitable for the case where one of directions of transmission axes of light transmitting part for a right eye and for a left eye is set in the vertical direction.

In the second passive glasses of the present invention, the polarization conversion layer may be a λ/2 plate. This further improves the visibility.

The present invention also provides a stereoscopic image projection system comprising the first or second passive glasses of the present invention. This allows the viewer wearing polarizing sunglasses to enjoy improved visibility in a stereoscopic image projection system of the passive system.

### ADVANTAGEOUS EFFECTS OF INVENTION

The active shutter glasses, passive glasses, and stereoscopic image projection system of the present invention enable to suppress lowering of the screen brightness sensed by the viewer wearing polarizing sunglasses, so as to be suitably used for a stereoscopic image projection system displaying bright stereoscopic video without accompanying increase in power consumption.

### BRIEF DESCRIPTION OF DRAWINGS

FIG. 1 is a schematic perspective view illustrating a configuration of a stereoscopic image projection system of Embodiment 1.

FIG. 2 is a schematic perspective view illustrating a configuration of active shutter glasses of Embodiment 1.

FIG. 3 is a schematic perspective view illustrating a configuration of the stereoscopic image projection system of Embodiment 1.

FIG. 4 is schematic perspective view illustrating a configuration of the stereoscopic image projection system of Embodiment 1.

FIG. 5 is a schematic plan view illustrating a configuration of the active shutter glasses of Embodiment 1.

FIG. 6 is a schematic perspective view illustrating a configuration of the stereoscopic image projection system of Embodiment 1.

FIG. 7 is a schematic perspective view illustrating a configuration of the stereoscopic image projection system of Embodiment 1.

FIG. 8 is a schematic perspective view illustrating a configuration of a stereoscopic image projection system of Embodiment 2.

FIG. 9 is a schematic perspective view illustrating a configuration of the stereoscopic image projection system of Embodiment 2.

FIG. 10 is a schematic perspective view illustrating a configuration of a stereoscopic image projection system of Embodiment 3.

FIG. 11 is a schematic perspective view illustrating a configuration of the stereoscopic image projection system of Embodiment 3.

FIG. 12 is a schematic perspective view illustrating a configuration of a stereoscopic image projection system of Embodiment 4.

FIG. 13 is a schematic perspective view illustrating a configuration of a stereoscopic image projection system of Embodiment 5.

FIG. 14 is a schematic perspective view illustrating a configuration of a stereoscopic image projection system of a comparative embodiment.

FIG. 15 is a schematic perspective view illustrating a configuration of passive glasses of a comparative embodiment.

FIG. 16 is a schematic perspective view illustrating a configuration of passive glasses of a comparative embodiment.

FIG. 17 is a schematic perspective view illustrating a configuration of passive glasses of a comparative embodiment.

FIG. 18 is a schematic perspective view illustrating a configuration of passive glasses of a comparative embodiment.

### DESCRIPTION OF EMBODIMENTS

The inner side and the outer side of glasses herein respectively refer to the viewer side of the glasses worn by the viewer and the other side of the glasses.

Further, the front side and the back side of a video display device herein respectively refer to the viewer side and the other side thereof.

A linearly polarizing element has a function of extracting polarized light (linearly polarized light) vibrating only in a specific direction from unpolarized light (natural light), partially polarized light, or polarized light. Unless otherwise indicated, a “linearly polarizing element” herein refers only to an element that includes no protective film and has a polarizing function.

A λ/4 plate herein is a layer having substantially one-quarter wavelength retardation at least for light of a wavelength of 550 nm. The retardation of the λ/4 plate is, more precisely, 137.5 nm for light of a wavelength of 550 nm. However, the retardation of the λ/4 plate may be 100 nm or more and 180 nm or less, and is preferably 120 nm or more and 160 nm or less, and more preferably 130 nm or more and 145 nm or less.

A λ/2 plate herein is a layer having substantially half wavelength retardation at least for light of a wavelength of 550 nm. The retardation of the λ/2 plate is, more precisely, 275 nm for light of a wavelength of 550 nm. However, the retardation of the λ/2 plate may be 220 nm or more and 320 nm or less, and is preferably 240 nm or more and 300 nm or less, and more preferably 260 nm or more and 280 nm or less.

In-plane phase difference R is defined as R=|nx−ny|×d (unit: nm) wherein nx and ny indicate the principal refractive indexes in the in-plane direction of a birefringent layer (including a liquid crystal cell, a λ/4 plate and a λ/2 plate), nz indicates the principal refractive index in the off-plane direction (thickness direction), and d indicates the thickness of the birefringent layer. In contrast, the thickness-direction phase difference Rth is an off-plane (thickness direction) phase difference (unit: nm) defined as

Rth=(nz−(nx+ny)/2)×d.

A polarization conversion layer herein refers to a layer converting polarization and preferably a layer converting linear polarization.

A depolarizer herein refers to an element eliminating the polarization, and the depolarization degree thereof is not particularly limited.

The present invention will be mentioned in more detail referring to the drawings in the following embodiments, but is not limited to these embodiments.

### Embodiment 1

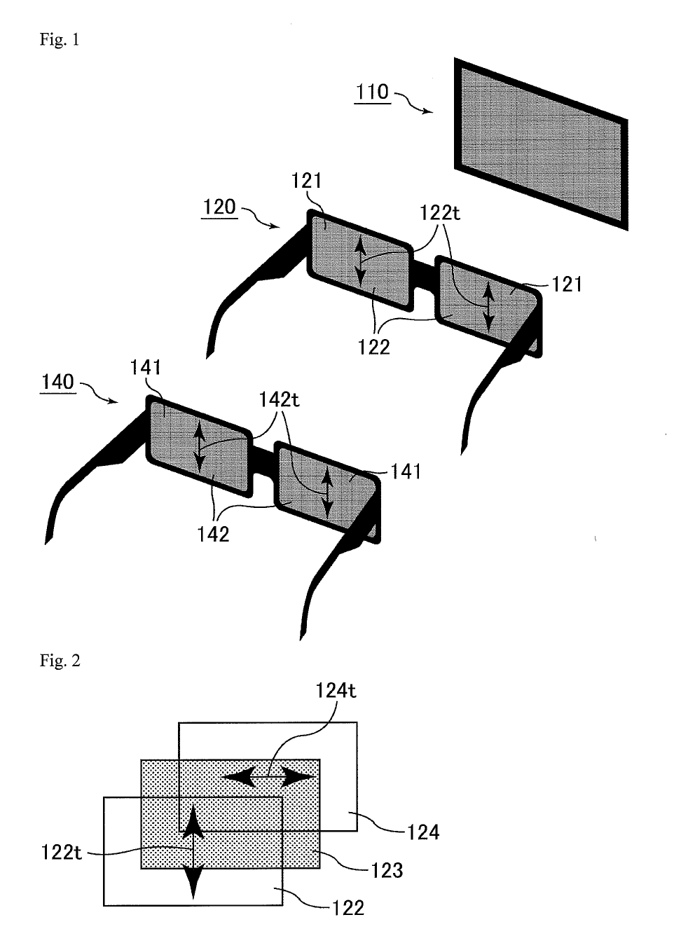

A stereoscopic image projection system of an active shutter system of the present embodiment has, as illustrated in FIG. 1, a video display device (3D display device) 110 and active shutter glasses 120.

A video signal for a right eye and a video signal for a left eye are alternately supplied to the display device 110, and images for a right eye and for a left eye having parallax therebetween are alternately displayed in a time division manner on the screen of the display device 110.

The glasses 120 have shutters 121 for a right eye and for a left eye (hereinbelow, also referred to as right and left shutters). The glasses 120 can alternately switch between a light transmitting state and a light shielding state (opening and closing states) of the right and left shutters 121. The switching timing is synchronized with an image for a right eye and an image for a left eye. Thereby, an image for a right eye is projected on the viewer's right eye and an image for a left eye is projected on the viewer's left eye, which allows the viewer to see a stereoscopic video.

The right and left shutters 121 respectively have, as illustrated in FIG. 2, a linearly polarizing element (inner polarizing element) 122, a liquid crystal cell 123, and a linearly polarizing element (outer linearly polarizing element) 124 in the stated order from the inner side.

Here, the viewer further wears the glasses 120 on polarizing sunglasses 140. The sunglasses 140 has light transmitting parts 141 for a right eye and for a left eye (hereinafter, also referred to as right and left light transmitting parts) respectively provided with linearly polarizing elements 142. Transmission axes 142t of the linearly polarizing elements 142 are set in the vertical direction when the sunglasses 140 are worn by the viewer.

Transmission axes 122t of the inner polarizing elements 122 are also set in the vertical direction when the glasses 120 are worn by the viewer. In this manner, the direction of the transmission axes 122t and the transmission axes 142t of the sunglasses 140 are aligned. Accordingly, the substantial entirety of the polarized light having passed through the right and left shutters 121 can pass through the sunglasses 140. Namely, the viewer can see stereoscopic video with substantially the same brightness as in the case of not wearing the sunglasses 140.

The direction of the transmission axes 122t of the inner polarizing elements 122 forms an angle, in a state where the viewer wears the glasses 120, preferably of 70° to 110°, more preferably 80° to 100°, and still more preferably 85° to 95° with the line drawn between the right eye and the left eye of the viewer.

The liquid crystal cell 123 is not particularly limited as long as it can secure the response speed that allows synchronization with a frame rate of the display device 110. Exemplary liquid crystal modes of the liquid crystal cell 123 include the twisted nematic (TN) mode, the optically compensated birefringence (OCB) mode, the vertical alignment (VA) mode, and the in-plane switching (IPS) mode. The liquid crystal cell 123 has two transparent substrates, a liquid crystal layer between the two substrates, and a transparent electrode formed at least one of the two substrates.

The inner polarizing element 122 and the outer polarizing element 124 may be disposed in a parallel Nicol state with each other, but are commonly disposed in a cross Nicol state with each other.

A birefringent layer may be appropriately provided between the outer polarizing element 124 and the inner polarizing element 122 for the purpose of optical compensation.

The display device 110 is not particularly limited, and examples thereof include a liquid crystal display device, a plasma display, an organic or inorganic EL display, a CRT display, and a projector.

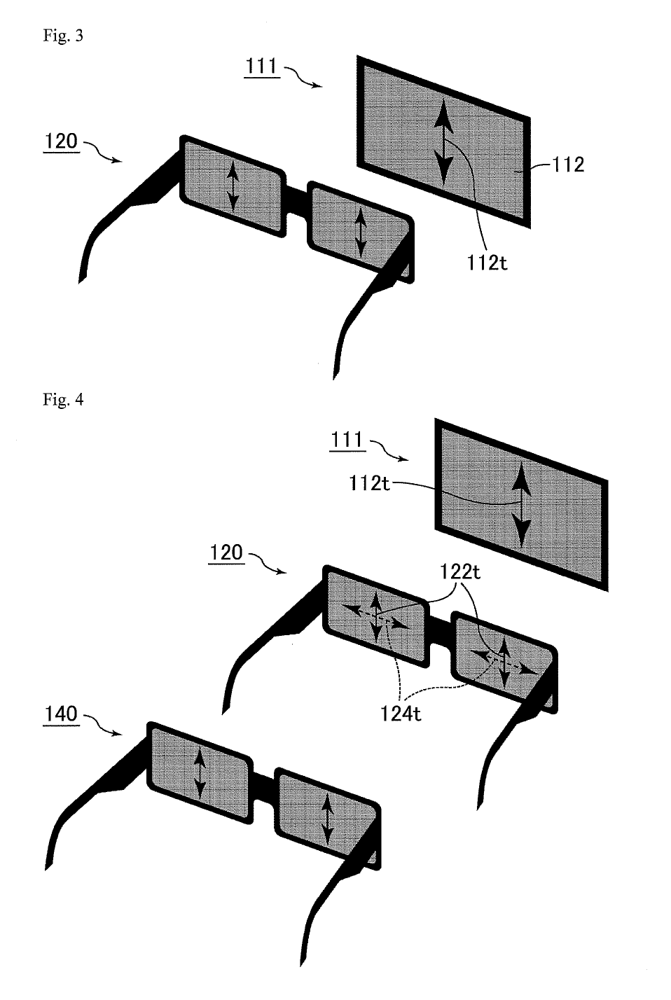

Recent liquid crystal display devices for TV are commonly VA or IPS mode devices. In most of such devices, as illustrated in FIG. 3, a transmission axis 112t of a linearly polarizing element 112 provided on a side closer to the viewer than the liquid crystal cell is, is set in the vertical direction. This is for allowing, with no special treatment such as adding new members, the viewer wearing the sunglasses 140 to see the screen without lowering of the brightness.

In the case of configuring, especially, a stereoscopic image projection system of the active shutter system with use of the liquid crystal display device 111 and the glasses 120 mentioned above, the system may not function well. The reason for this is as follows. The inner polarizing element 122 and the outer polarizing element 124 of the glasses 120 are commonly disposed in a cross Nicol state with each other. Namely, if the transmission axes 122t of the inner polarizing elements 122 are set in the vertical direction for solving the problems which may be caused by use of polarizing sunglasses in combination, as illustrated in FIGS. 4 and 5, the transmission axes 124t of the outer polarizing elements 124 may be automatically set in the lateral direction. Accordingly, the transmission axes 124t are orthogonal to the transmission axis 112t of the liquid crystal display device 111. As a result, light exiting from the liquid crystal display device 111 may be absorbed by the outer polarizing element 124, failing to pass through the glasses 120. That is, the viewer's sight may become black. To solve this problem, in the case where a liquid crystal display device is used as the display device 110, a system of the following modified example is preferably employed.

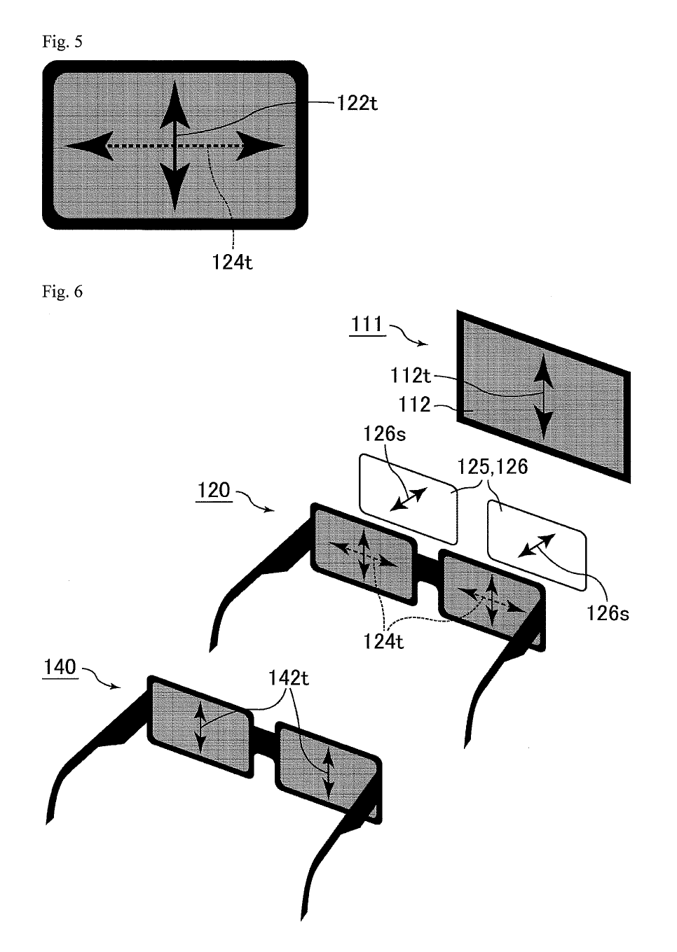

In the present modified example, as illustrated in FIG. 6, the polarizing elements 124 are each provided with a polarization conversion layer 125 on the outer side. This allows appropriate conversion of polarization of light exiting from the linearly polarizing element 112 of the liquid crystal display device 111 by the polarization conversion layers 125. Accordingly, at least a part of the light exiting from the linearly polarizing element 112 can pass through the outer polarizing elements 124. Namely, even in the case where the transmission axes 124t and the transmission axis 112t are orthogonal to each other, the viewer can see stereoscopic video.

The polarization conversion layers 125 are not particularly limited, and examples thereof include a birefringent layer and a depolarizer. Examples of the birefringent layer include a λ/2 plate and a λ/4 plate.

Particularly, λ/2 plates are preferably used as the polarization conversion layers 125. FIG. 6 illustrates an embodiment where λ/2 plates 126 are provided as the polarization conversion layers 125. The λ/2 plates 126 can appropriately rotate the polarization (vibration) direction of the polarized light. Accordingly, it is possible to align the polarization direction of the polarized light exiting from the λ/2 plates 126 with the transmission axes 124t of the outer polarizing element 124. The polarized light exiting from the λ/2 plates 126 can efficiently pass through the glasses 120. As a result, the viewer can see bright stereoscopic video.

At this time, slow axes 126s of the λ/2 plates 126 are each set in a direction substantially bisecting the angle between the transmission axis 112t of the linearly polarizing element 112 and the transmission axes 124t of the outer polarizing elements 124. The slow axes 126s are each preferably set within a range of ±10°, more preferably ±5°, and still more preferably ±3°, from the direction bisecting the angle between the transmission axis 112t and the transmission axes 124t. Here, these numerical ranges include boundary values.

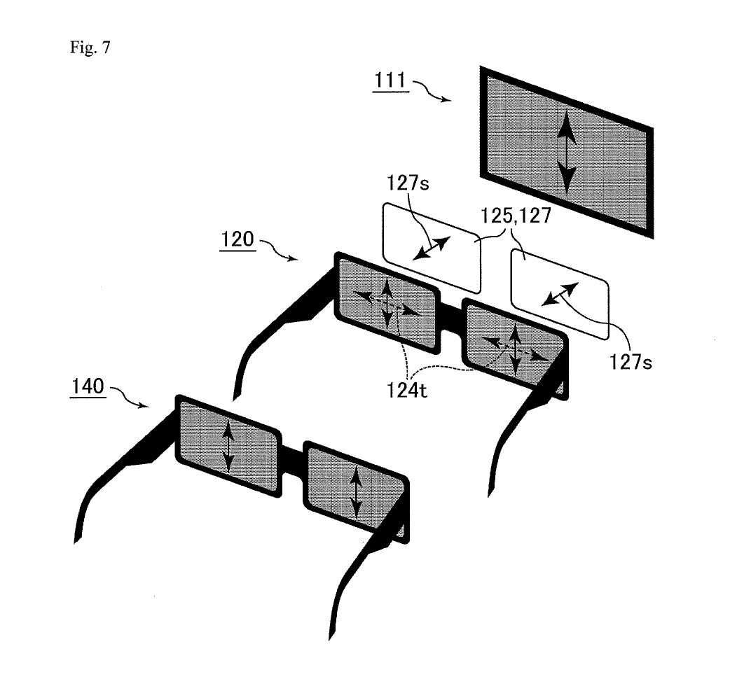

FIG. 7 shows an embodiment where λ/4 plates 127 are provided as the polarization conversion layers 125. The λ/4 plates 127 can convert the linear polarization to circular polarization. Accordingly, the polarized light exiting from the λ/4 plates 127 is converted to circularly polarized light, so that a part of that light can pass through the outer polarizing elements 124. As a result, even in the case where the transmission axes 124t and the transmission axis 112t are orthogonal to each other, the viewer can see stereoscopic video.

At this time, slow axes 127s of the λ/4 plates 127 are each set in a direction forming an angle of 45° with each transmission axis 124t of the linearly polarizing element 124. The angles formed between the slow axes 127s and the transmission axes 124t are each preferably in a range of 35° to 55°, more preferably 40° to 50°, and still more preferably 42° to 48°. Here, these numerical ranges include boundary values.

### Embodiment 2

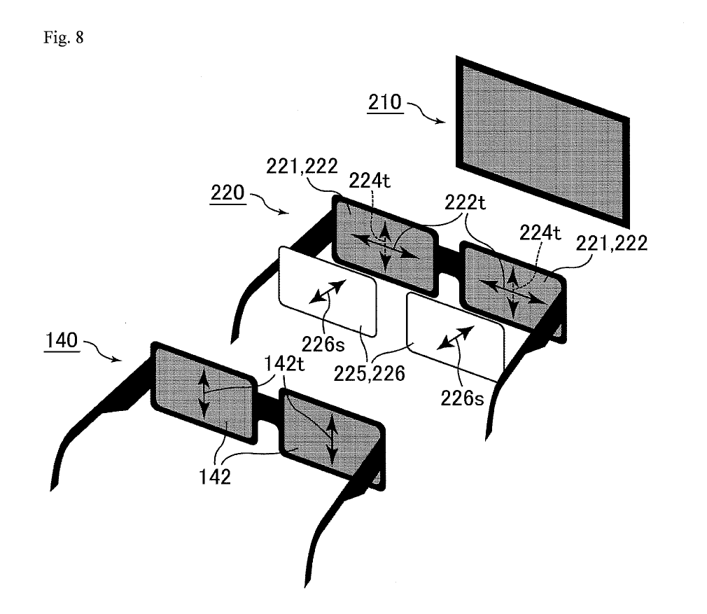

A stereoscopic image projection system of an active shutter system of the present embodiment has, as illustrated in FIG. 8, a video display device (3D display device) 210 and active shutter glasses 220.

In the same manner as in Embodiment 1, images for a right eye and for a left eye having parallax therebetween are alternately displayed in a time division manner on the screen of the display device 210. The glasses 220 have shutters 221 for a right eye and for a left eye (hereinbelow, also referred to as right and left shutters). The glasses 220 can alternately switch between a light transmitting state and a light shielding state (opening and closing states) of the right and left shutters 221.

The right and left shutters 221 each have, as the shutters 121 do, a linearly polarizing element (inner polarizing element) 222, a liquid crystal cell (not illustrated), and a linearly polarizing element (outer polarizing element) 224 in the stated order from the inner side. The liquid crystal cell of the glasses 220 can have the same configuration as the liquid crystal cell 123 of the glasses 120.

The inner polarizing element 222 and the outer polarizing element 224 may be disposed in a parallel Nicol state with each other, but are commonly disposed in a cross Nicol state.

A birefringent layer may be appropriately provided between the outer polarizing element 224 and the inner polarizing element 222 for the purpose of optical compensation.

The display device 210 is not particularly limited, and examples thereof include a liquid crystal display device, a plasma display, an organic or inorganic EL display, a CRT display, and a projector.

The viewer further wears the glasses 220 on polarizing sunglasses 140 in the same manner as in Embodiment 1.

The glasses 220 further has a polarization conversion layer 225 provided on the inner side of each inner polarizing element 222. This allows appropriate conversion of polarization of light exiting from the inner polarizing elements 222 by the polarization conversion layers 225 even in the case where the directions of the transmission axes 222t of the inner polarizing elements 222 and the transmission axes 142t of the linearly polarizing elements 142 are different from each other. Therefore, the light having passed through the polarization conversion layers 225 can have a relatively small amount of polarization components vibrating in the lateral direction and a relatively large amount of polarization components vibrating in the vertical direction. In this manner, the amount of light passing through the sunglasses 140 can be increased.

As above, according to the present embodiment, the viewer wearing the sunglasses 140 can see stereoscopic video, regardless of the direction of the transmission axes 222t of the inner polarizing elements 222.

Moreover, since the direction of the transmission axes 222t can be appropriately set, the transmission axes 224t of the outer polarizing elements 224 can be set in the vertical direction even in the case where the inner polarizing elements 222 and the outer polarizing elements 224 are disposed in a cross Nicol state with each other. Accordingly, even in the case where a liquid crystal display device is used as the display device 210, it is possible to suppress occurrence of problems as described in Embodiment 1.

The polarization conversion layers 225 are not particularly limited, and examples thereof include a birefringent layer and a depolarizer. Examples of the birefringent layers include a λ/2 plate and a λ/4 plate.

In particular, λ/2 plates are suitably used as the polarization conversion layers 225, from the same standpoint as in Embodiment 1. FIG. 8 illustrates an embodiment where λ/2 plates 226 are provided as the polarization conversion layers 225. This configuration enables the viewer to see bright stereoscopic video.

At this time, the slow axes 226s of the λ/2 plates 226 are each set in a direction substantially bisecting the angles between the transmission axes 222t of the linearly polarizing element 222 and the transmission axes 142t of the outer polarizing element 142. The slow axes 226s are preferably set within a range of ±10°, more preferably ±5°, and still more preferably ±3°, from the direction bisecting the angles between the transmission axes 222t and the transmission axes 142t. Here, these numerical ranges include boundary values.

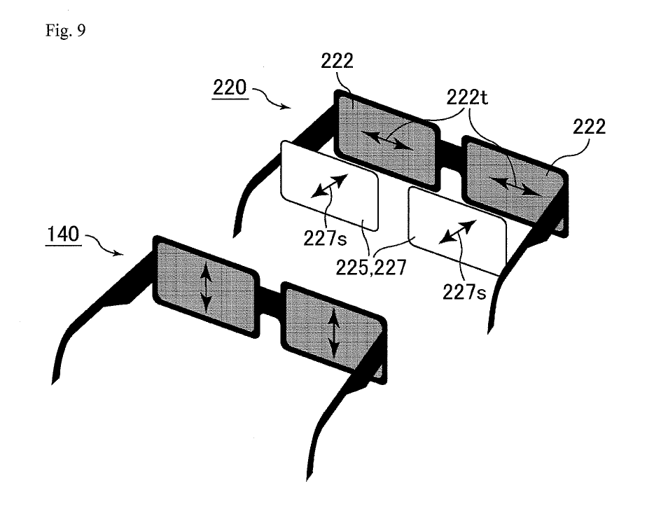

FIG. 9 illustrates an embodiment where λ/4 plates 227 are provided as the polarization conversion layers 225. In this case, light exiting from the λ/4 plates 227 is circularly polarized, and therefore, a part of the light can pass through the sunglasses 140. Accordingly, the viewer wearing the sunglasses 140 can see stereoscopic video, regardless of the direction of the transmission axes 222t of the inner polarizing elements 222.

At this time, slow axes 227s of the λ/4 plate 227 are set in a direction forming an angle of about 45° with the transmission axes 222t of the inner polarizing elements 222. The angle formed between the slow axes 227s and the transmission axes 222t is preferably in a range of 35° to 55°, more preferably 40° to 50°, and still more preferably 42° to 48°. Here, these numerical ranges include boundary values.

### Embodiment 3

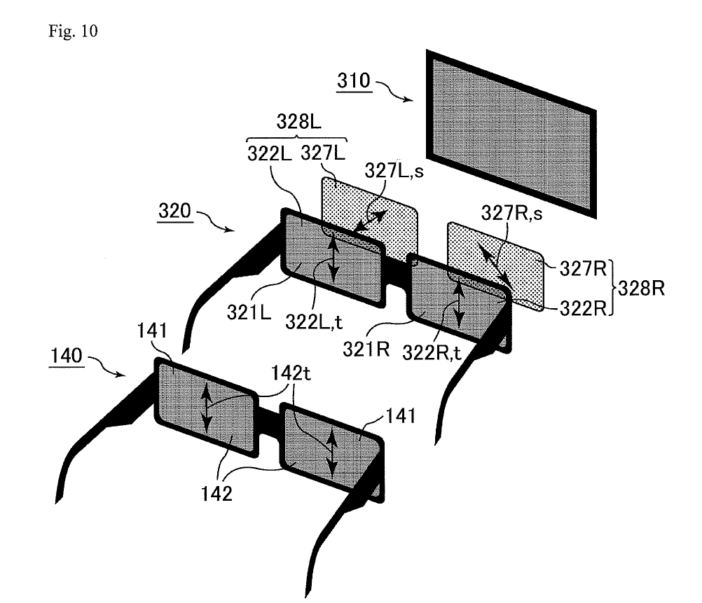

A stereoscopic image projection system of the passive system of the present embodiment has, as illustrated in FIG. 10, a video display device (3D display device) 310 and passive glasses 320.

A video signal for a right eye and a video signal for a left eye are supplied to the display device 310, and images for a right eye and for a left eye having parallax therebetween are simultaneously or alternately displayed on the display device 310. On the front side of the screen of the display device 310, a switching cell, namely a liquid crystal cell may be provided which can reversibly convert the vibration direction of the polarized light by the presence or absence of voltage application. This enables alternate display of the images for a right eye and for a left eye in a time division manner. The display device 310 may have two projectors and a screen. This configuration allows simultaneous display of the images for a right eye and for a left eye. Moreover, the display device 310 may have a patterned retarder, namely a retardation layer patterned in each pixel region, on the screen. This configuration allows simultaneous display of the images for a right eye and for a left eye in a state where they are spatially divided.

The image for a right eye is displayed by clockwise circularly polarized (from the viewer position) light and the image for a left eye is displayed by counter-clockwise circularly polarized (from the viewer position) light.

The glasses 320 have a light transmitting part 321R for a right eye and a light transmitting part 321L for a left eye. The light transmitting part 321R does not transmit an image for a left eye and only transmits an image for a right eye. The light transmitting part 321L does not transmit an image for a right eye and only transmits an image for a left eye. More specifically, the light transmitting part 321R has a circularly polarizing plate 328R in which a linearly polarizing element 322R and a λ/4 plate 327R are stacked in the stated order from the inner side. The light transmitting part 321L has a circularly polarizing plate 328L in which a linearly polarizing element 322L and a λ/4 plate 327L are stacked in the stated order from the inner side. The circularly polarizing plate 328R only transmits clockwise circularly polarized (from the viewer position) light. The circularly polarizing plate 328L only transmits counter-clockwise circularly polarized (from the viewer position) light. In this manner, an image for a right eye is projected on the right eye of the viewer and an image for a left eye is projected on the left eye of the viewer, so that the viewer can see stereoscopic video.

Here, the viewer further wears the glasses 320 on the sunglasses 140 in the same manner as in Embodiment 1.

A transmission axis 322R,t of the linearly polarizing element 322R is set in the vertical direction when the viewer wears the glasses 320. A transmission axis 322L,t of the linearly polarizing element 322L is set in the vertical direction when the viewer wears the glasses 320. In this manner, the direction of the transmission axes 322R,t and 322L,t and the transmission axes 142t of the polarizing sunglasses are aligned. Accordingly, the substantial entirety of the polarized light exiting from the light transmitting parts 321R and 321L can pass through the sunglasses 140. Namely, the viewer wearing the sunglasses 140 can see stereoscopic video with the same brightness as in the case of not wearing the sunglasses 140.

A slow axis 327R,s of the λ/4 plate 327R is set in a direction of the line between 135° and 315° and a slow axis 327L, s of the λ/4 plate 327L is set in a direction of the line between 45° and 225°, wherein the right direction (3 o'clock position) from the side of the viewer wearing the glasses 320 is set to 0° and the counter-clockwise direction is set as a positive direction (hereinafter, this condition is referred to as standard measurement condition).

The display device 310 is not particularly limited, and examples thereof include a liquid crystal display device, a plasma display, an organic or inorganic EL display, a CRT display, and a projector.

Hereinafter, a description is given on a modified example of the present embodiment.

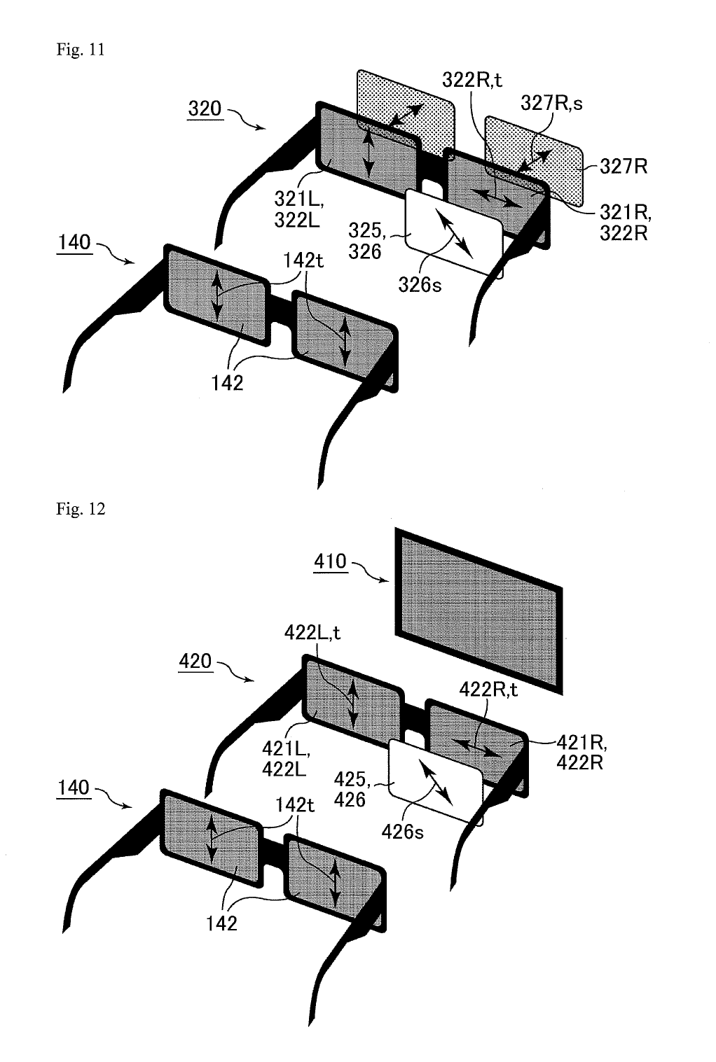

As illustrated in FIG. 11, in the present modified example, the axial directions of the linearly polarizing element 322R and the λ/4 plate 327R are rotated by 90° in the clockwise direction from the viewer position. That is, the transmission axis 322R,t of the linearly polarizing element 322R is set in the lateral direction when the viewer wears the glasses 320. The slow axis 327R, s of the λ/4 plate 327R is set in a direction of the line between 45° and 225° under the standard measurement condition. Accordingly, the polarized light exiting from the linearly polarizing element 322R cannot pass through the sunglasses 140.

In the present modified example, the polarization conversion layer 325 is provided on an inner side than the linearly polarizing element 322R is. This configuration allows appropriate conversion of light exiting from the linearly polarizing element 322R by the polarization conversion layer 325. Therefore, the light having passed through the polarization conversion layer 325 can have a relatively small amount of polarization components vibrating in the lateral direction and a relatively large amount of polarization components vibrating in the vertical direction. In this manner, the amount of light passing through the sunglasses 140 can be increased.

As above, according to the present modified example, an image for aright eye is projected on the right eye of the viewer wearing the sunglasses 140 so that the viewer can see stereoscopic video, regardless of the direction of the transmission axis 322R,t of the inner polarizing element 322R.

The polarization conversion layer 325 is not particularly limited, and examples thereof include a birefringent layer and a depolarizer. Examples of the birefringent layer include a λ/2 plate and a λ/4 plate.

In particular, a λ/2 plate is suitably used as the polarization conversion layer 325, from the same standpoint as in Embodiment 1. FIG. 11 illustrates an embodiment where a λ/2 plate 326 is provided as the polarization conversion layer 325. This configuration enables the viewer to see bright stereoscopic video.

At this time, a slow axis 326s of the λ/2 plate 326 is set in a direction substantially bisecting the angle between the transmission axis 322R,t of the linearly polarizing element 322R and the transmission axis 142t of the linearly polarizing element 142. The slow axis 326s is preferably set within a range of ±10°, more preferably ±5°, and still more preferably ±3°, from the direction bisecting the angle between the transmission axis 322R,t and the transmission axis 142t of the linearly polarizing element 142 in the light transmitting part for a right eye. Here, these numerical ranges include boundary values.

In the present modified example, the configuration of the light transmitting part 321R and the configuration of the light transmitting part 321L may be switched with each other.

### Embodiment 4

A stereoscopic image projection system of the passive system of the present embodiment has, as illustrated in FIG. 12, a video display device (3D display device) 410 and passive glasses 420.

On the display device 410, images for a right eye and for a left eye having parallax therebetween are simultaneously or alternately displayed in the same manner as in Embodiment 3. In the present embodiment, however, an image for a right eye is displayed by linearly polarized light vibrating in the lateral direction and an image for a left eye is displayed by linearly polarized light vibrating in the vertical direction.

The display device 410 is not particularly limited, and examples thereof include a liquid crystal display device, a plasma display, an organic or inorganic EL display, a CRT display, and a projector.

The glasses 420 have a light transmitting part 421R for a right eye and a light transmitting part 421L for a left eye. The light transmitting part 421R does not transmit an image for a left eye and only transmits an image for a right eye. The light transmitting part 421L does not transmit an image for a right eye and only transmits an image for a left eye. More specifically, the light transmitting part 421R has a linearly polarizing element 422R and the light transmitting part 421L has a linearly polarizing element 422L. A transmission axis 422R,t of the linearly polarizing element 422R is set in the lateral direction when the viewer wears the glasses 420. A transmission axis 422L,t of the linearly polarizing element 422L is set in the vertical direction when the viewer wears the glasses 420. This allows the linearly polarizing element 422R to transmit only an image for a right eye and the linearly polarizing element 422L to transmit only an image for a left eye.

Here, the viewer further wears the glasses 420 on the sunglasses 140 in the same manner as in Embodiment 1. Accordingly, the polarized light exiting from the linearly polarizing element 422R cannot pass through the sunglasses 140.

To solve this problem, the glasses 420 are further provided with a polarization conversion layer 425 on an inner side than the linearly polarizing element 422R is. This configuration allows appropriate conversion of light exiting from the linearly polarizing element 422R by the polarization conversion layer 425. Therefore, the light having passed through the polarization conversion layer 425 can have a relatively small amount of polarization components vibrating in the lateral direction and a relatively large amount of polarization components vibrating in the vertical direction. In this manner, the amount of light passing through the sunglasses 140 can be increased.

As above, according to the present embodiment, an image for a right eye is projected on the right eye of the viewer wearing the sunglasses 140 so that the viewer can see stereoscopic video, regardless of the direction of the transmission axis 422R,t of the linearly polarizing element 422R.

The polarization conversion layer 425 is not particularly limited, and examples thereof include a birefringent layer and a depolarizer. Examples of the birefringent layer include a λ/2 plate and a λ/4 plate.

In particular, a λ/2 plate is suitably used as the polarization conversion layer 425, from the same standpoint as in Embodiment 1. FIG. 12 illustrates an embodiment where a λ/2 plate 426 is provided as the polarization conversion layer 425. This configuration enables the viewer to see bright stereoscopic video.

At this time, a slow axis 426s of the λ/2 plate 426 is set in a direction substantially bisecting the angle between the transmission axis 422R, t of the linearly polarizing element 422R and the transmission axis 142t of the linearly polarizing element 142 in the light transmitting part for aright eye. The slow axis 426s is preferably set within a range of ±10°, more preferably ±5°, and still more preferably ±3°, from the direction bisecting the angle between the 422R,t and the transmission axis 142t of the linearly polarizing element 142 in the light transmitting part for a right eye. Here, these numerical ranges include boundary values.

In the present embodiment, the configuration of the light transmitting part 421R and the configuration of the light transmitting part 421L may be switched with each other.

### Embodiment 5

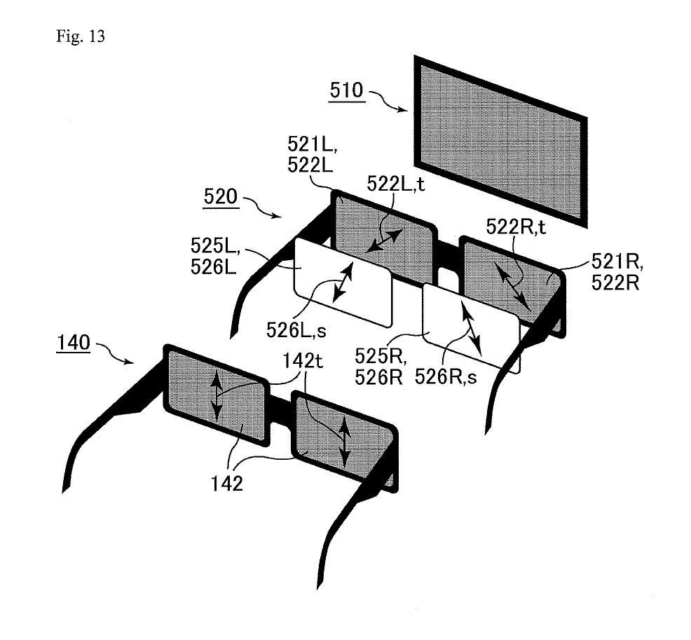

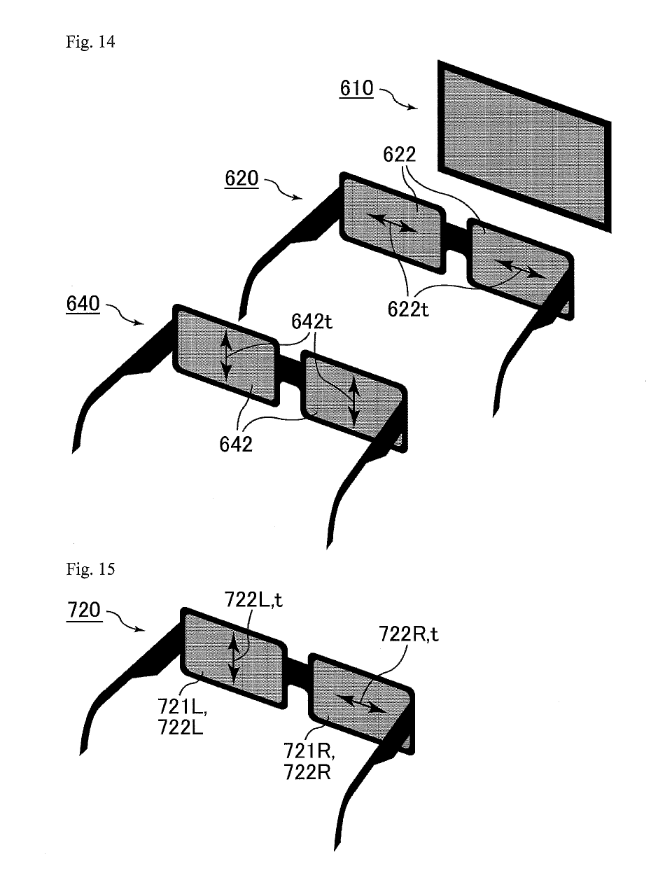

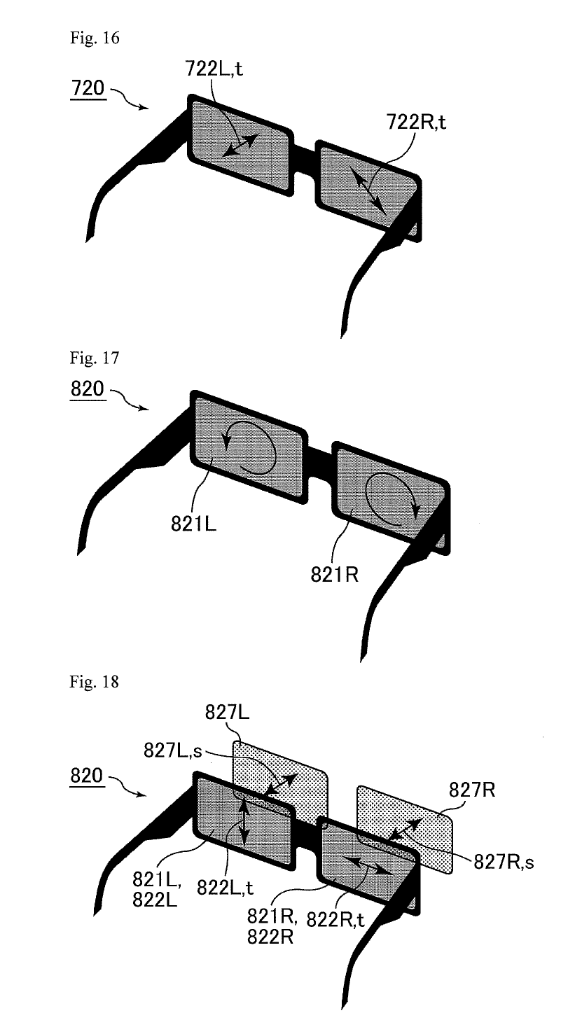

A stereoscopic image projection system of the passive system of the present embodiment has, as illustrated in FIG. 13, a video display device (3D display device) 510 and passive glasses 520.

On the display device 510, images for a right eye and for a left eye having parallax therebetween are simultaneously or alternately displayed in the same manner as in Embodiment 3. In the present embodiment, an image for a right eye is displayed by linearly polarized light vibrating in a direction of the line between 135° and 315° and an image for a left eye is displayed by linearly polarized light vibrating in a direction of the line between 45° and 225°, wherein the right direction (3 o'clock position) from the side of the viewer watching the screen of the display device 510 from the front is set to 0° and the counter-clockwise direction is set as a positive direction.

The display device 510 is not particularly limited, and examples thereof include a liquid crystal display device, a plasma display, an organic or inorganic EL display, a CRT display, and a projector.

The glasses 520 have a light transmitting part 521R for a right eye and a light transmitting part 521L for a left eye. The light transmitting part 521R does not transmit an image for a left eye and only transmits an image for a right eye. The light transmitting part 521L does not transmit an image for a right eye and only transmits an image for a left eye. More specifically, the light transmitting part 521R has a linearly polarizing element 522R and the light transmitting part 521L has a linearly polarizing element 522L. A transmission axis 522R,t of the linearly polarizing element 522R is set in a direction of the line between 135° and 315° under the standard measurement conditions. A transmission axis 522L,t of the linearly polarizing element 522L is set in a direction of the line between 45° and 225° under the standard measurement conditions. This allows the linearly polarizing element 522R to transmit only an image for a right eye and the linearly polarizing element 522L to transmit only an image for a left eye.

Here, the viewer further wears the glasses 520 on the sunglasses 140 in the same manner as in Embodiment 1. Accordingly, a part of the polarized light exiting from the linearly polarizing elements 522R and 522L cannot pass through the sunglasses 140, so that the viewer cannot see bright stereoscopic video.

To solve this problem, the glasses 520 are further provided with polarization conversion layers 525R and 525L respectively on an inner side than the linearly polarizing elements 522R and 522L are. This configuration allows appropriate conversion of light exiting from the linearly polarizing element 522R and light exiting from the linearly polarizing element 522L by the polarization conversion layers 525R and 525L. Therefore, the light having passed through the polarization conversion layers 525R and 525L can each have a relatively small amount of polarization components vibrating in the lateral direction and a relatively large amount of polarization components vibrating in the vertical direction. In this manner, the amount of light passing through the sunglasses 140 can be increased.

As above, according to the present embodiment, the viewer can see bright stereoscopic video regardless of the direction of the transmission axes 522R,t and 522L,t of the linearly polarizing elements 522R and 522L.

The polarization conversion layers 525R and 525L are not particularly limited, and examples thereof include a birefringent layer and a depolarizer. Examples of the birefringent layer include a λ/2 plate and a λ/4 plate.

In particular, λ/2 plates are suitably used as the polarization conversion layers 525R and 525L, from the same standpoint as in Embodiment 1. FIG. 13 illustrates an embodiment where λ/2 plates 526R and 526L are provided as the polarization conversion layers 525R and 525L. This configuration enables the viewer to see brighter stereoscopic video.

At this time, a slow axis 526R,s of the λ/2 plate 526R is set in a direction substantially bisecting the angle between the transmission axis 522R,t of the linearly polarizing element 522R and the transmission axis 142t of the linearly polarizing element 142 in the light transmitting part for a right eye. A slow axis 526L,s of the λ/2 plate 526L is set in a direction that substantially bisecting the angle between the transmission axis 522L,t of the linearly polarizing element 522L and the transmission axis 142t in the light transmitting part for a left eye. The slow axis 526R,s is preferably set within a range of ±10°, more preferably ±5°, and still more preferably ±3°, from the direction bisecting the angle between the transmission axis 522R,t and the transmission axis 142t of the linearly polarizing element 142 in the light transmitting part for a right eye. The slow axis 526L,s is preferably set within a range of ±10°, more preferably ±5°, and still more preferably ±3°, from the direction bisecting the angle between the transmission axis 522L,t and the transmission axis 142t of the linearly polarizing element 142 in the light transmitting part for a left eye. Here, these numerical ranges include boundary values.

The polarization conversion layers 525R and 525L preferably contain layers of the same kind.

Hereinafter, components used in Embodiment 1 to 5 are described.

Typical examples of the linearly polarizing element include a polyvinyl alcohol (PVA) film on which an anisotropic material such as dichromatic iodine complex is absorbed and aligned. For the purpose of securing the mechanical strength and the resistance to moist heat, a PVA film is commonly coated with protective films such as triacetylcellulose (TAC) film on the both faces to be practically used.

The material of the birefringent layer such as a λ/2 plate and a λ/4 plate is not particularly limited, and may be a stretched polymer film, for example. Examples of the polymer include polycarbonate, polysulfone, polyethersulfone, polyethylene terephthalate, polyethylene, polyvinyl alcohol, norbornene, triacetylcellulose, and diacetylcellulose.

A formation method of the λ/2 plate and the λ/4 plate is not particularly limited. The linearly polarizing element and each of the λ/2 plate and the λ/4 plate are stacked in layers in such a manner that the slow axis forms a predetermined angle with the transmission axis of the linearly polarizing element. Accordingly, the λ/2 plate and the λ/4 plate are preferably formed by an obliquely stretching method in which the λ/2 plate and the λ/4 plate are stretched and aligned in the direction oblique to the flowing direction of the roll film.

The depolarizer is not particularly limited, and examples thereof include a transparent resin film in which fine particles formed of an inorganic birefringent material such as calcite, an ultrashort fibrous material prepared by finely cutting birefringent fibers, or the like is dispersed. Also, a formation method of the depolarizer is not particularly limited.

The polarization conversion layer is preferably adjacent to the linearly polarizing element. Namely, no birefringent layer is preferably formed between the polarization conversion layer and the linearly polarizing element. This configuration allows easier conversion of polarization of the linearly polarized light to a desired state. An isotropic film may be provided between the polarization conversion layer and the linearly polarizing element. However, it is acceptable that the birefringent layer is provided between the polarization conversion layer and the linearly polarizing element. Even in this case, if the slow axis of the birefringent layer is set in a direction substantially parallel with or substantially orthogonal to the transmission axis of the linearly polarizing element, the polarization conversion function of the birefringent layer is practically disabled. In this manner, the same effect can be obtained as in the case where the birefringent layer is not provided between the polarization conversion layer and the linearly polarizing element. Here, when “substantially parallel” is referred, an angle between the axes is preferably within 0°±3°, and more preferably 0°±1°. Moreover, when “substantially orthogonal” is referred, an angle between the axes is preferably within 90°±3°, and more preferably 90°±1°. Here, these numerical ranges include boundary values.

The birefringent layer refers to a layer having optical anisotropy, and refers to a layer in which at least one of the absolute value of the in-plane phase difference R and the absolute value of the thickness-direction phase difference Rth has a value of 10 nm or more and preferably 20 nm or more.

The isotropic film refers to a film in which each of the absolute value of the in-plane phase difference R and the absolute value of the thickness-direction phase difference Rth has a value of 10 nm or less and preferably 5 nm or less.

The present application claims priority to Patent Application No. 2010-51000 filed in Japan on Mar. 8, 2010 under the Paris Convention and provisions of national law in a designated State, the entire contents of which are hereby incorporated by reference.

### REFERENCE SIGNS LIST

110, 210, 310, 410, 510: Video display device
111: Liquid crystal display device
112, 122, 124, 142, 222, 224, 322R, 322L, 422R, 422L, 522R, 522L: Linearly polarizing element
120, 220: Active shutter glasses
121, 221: Shutter
123: Liquid crystal cell
125, 225, 325, 425, 525R, 525L: Polarization conversion layer
126, 226, 326, 426, 526R, 526L: λ/2 plate
127, 227, 327R, 327L: λ/4 plate
140: Polarizing sunglasses
141, 321R, 321L, 421R, 421L, 521R, 521L: light transmitting part
320, 420, 520: Passive glasses
328R, 328L: Circularly polarizing plate

1. Active shutter glasses for a stereoscopic image projection system, comprising:
a shutter for a right eye; and
a shutter for a left eye,
wherein
the shutters for a right eye and for a left eye each include a liquid crystal cell and a linearly polarizing element,
the linearly polarizing element is provided in each shutter on an inner side than the liquid crystal cell is,
the linearly polarizing element has a transmission axis direction set in the vertical direction when the glasses are worn.

2. The active shutter glasses according to claim 1,
wherein
the linearly polarizing element is a first linearly polarizing element,
the shutters for a right eye and for a left eye each further include a second linearly polarizing element and a polarization conversion layer for converting polarization,
the second linearly polarizing element is provided in each shutter on an outer side than the liquid crystal cell is, and
the polarization conversion layer is provided in each shutter on an outer side than the second linearly polarizing element is.

3. A stereoscopic image projection system comprising the active shutter glasses according to claim 1.

4. Active shutter glasses for a stereoscopic image projection system, comprising:
a shutter for a right eye; and
a shutter for a left eye,
wherein
the shutters for a right eye and for a left eye each include a liquid crystal cell, a linearly polarizing element, and a polarization conversion layer for converting polarization,
the linearly polarizing element is provided in each shutter on an inner side than the liquid crystal cell is,
the polarization conversion layer is provided in each shutter on an inner side than the linearly polarizing element is.

5. The active shutter glasses according to claim 4,
wherein
the polarization conversion layer is a λ/2 plate.

6. A stereoscopic image projection system comprising the active shutter glasses according to claim 4.

7. Passive glasses for a stereoscopic image projection system, comprising:
a light transmitting part for a right eye; and
a light transmitting part for a left eye,
wherein
the light transmitting parts for a right eye and for a left eye each include a linearly polarizing element, and
the linearly polarizing element has a transmission axis direction set in the vertical direction when the glasses are worn.

8. A stereoscopic image projection system comprising the passive glasses according to claim 7.

9. Passive glasses for a stereoscopic image projection system, comprising:
a light transmitting part for a right eye; and
a light transmitting part for a left eye,
wherein
the light transmitting parts for a right eye and for a left eye each include a linearly polarizing element, and
at least one of the light transmitting parts for a right eye and for a left eye includes a polarization conversion layer for converting polarization, and
the polarization conversion layer is provided in the light transmitting part on an inner side than the linearly polarizing element is.

10. The passive glasses according to claim 9,
wherein
the light transmitting parts for a right eye and for a left eye each include the polarization conversion layer.

11. The passive glasses according to claim 9,
wherein
one of the light transmitting parts for a right eye and for a left eye includes the polarization conversion layer.

12. The passive glasses according to claim 9,
wherein the polarization conversion layer is a λ/2 plate.

13. A stereoscopic image projection system comprising the passive glasses according to claim 9.
